(19) United States
(12) Patent Application Publication
(10) Pub. No.: US 2013/0148347 A1
(43) Pub. Date: Jun. 13, 2013

(54) ILLUMINATION DEVICE

(71) Applicant: Kuo-Jui Huang, Taichung City (TW)

(72) Inventor: Kuo-Jui Huang, Taichung City (TW)

(21) Appl. No.: 13/692,995

(22) Filed: Dec. 3, 2012

(30) Foreign Application Priority Data
Dec. 9, 2011 (TW) 100145558

(51) Int. Cl. F21V 1/00

(52) U.S. Cl. CPC F21V 1/00
USPC 362/235

(57) ABSTRACT

An illumination device including a lamp shade, a base, a plurality of light emitting elements, and a light guide member is provided. The base is connected to the lamp shade, so as to define a receiving space together. The light emitting elements are located in the receiving space and configured on an inner wall of the lamp shade. The light guide member is located in the receiving space and is connected to the base. The light guide member guides light rays emitted by the light emitting elements to the lamp shade.

### CROSS-REFERENCE TO RELATED APPLICATION

This application claims the priority benefit of Taiwan application serial no. 100145558, filed on Dec. 9, 2011. The entirety of the above-mentioned patent application is hereby incorporated by reference herein and made a part of this specification.

### BACKGROUND OF THE INVENTION

1. Field of the Invention

The present invention generally relates to an illumination device, in particular, to an illumination device having a light guide member.

2. Description of Related Art

With development of illumination technique, a more power saving and environmentally friendly light source, that is, an LED bulb, is developed. An LED in the LED bulb emits light by recombining electrons and holes in a P-N junction. Compared with an incandescent bulb or a fluorescent lamp, the LED bulb has advantages of low power consumption and long service life.

However, in a conventional LED bulb, in most cases, an LED is disposed on a heat dissipation base, so that most of light rays emitted by the LED bulb are concentrated on a front view direction, thereby causing a direct-vision glare problem to users. Compared with a conventional incandescent bulb, the conventional LED bulb has distinctive disadvantages in using.

### SUMMARY OF THE INVENTION

Accordingly, the present invention is directed to an illumination device, capable of modifying a glare problem of a conventional illumination device.

The present invention provides an illumination device, which includes a lamp shade, a base, a plurality of light emitting elements, and a light guide member. The base is connected to the lamp shade, so as to define a receiving space together with the lamp shade. The base has a plurality of brackets extending towards the lamp shade. The light emitting elements are located in the receiving space and configured on inner walls of the brackets. The light guide member is located within the receiving space and surrounded by the brackets. The light guide member guides light rays emitted by the light emitting elements to the lamp shade.

Based on the above mentioned, in an illumination device according to the present invention, the light rays emitted by light emitting elements located on an inner wall of the lamp shade may be uniformly distributed to each part of the lamp shade by the light guide member, so as to prevent a glare problem.

In order to make the aforementioned features and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of an illumination device according to an embodiment of the present invention.

FIG. 2 is a schematic cross-sectional view of an illumination device along a cross section A of FIG. 1.

FIG. 3 is a schematic cross-sectional view of an illumination device along a cross section B of FIG. 2.

FIG. 4 is a schematic three-dimensional view of a light guide member according to an embodiment of the present invention.

FIG. 5 is a schematic three-dimensional view of a light guide member according to an embodiment of the present invention.

FIG. 6 is a schematic cross-sectional view of an illumination device according to a second embodiment of the present invention.

FIG. 7 is a schematic three-dimensional view of an upper light guide portion of FIG. 6.

FIG. 8 is a schematic cross-sectional view of an illumination device according to a third embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

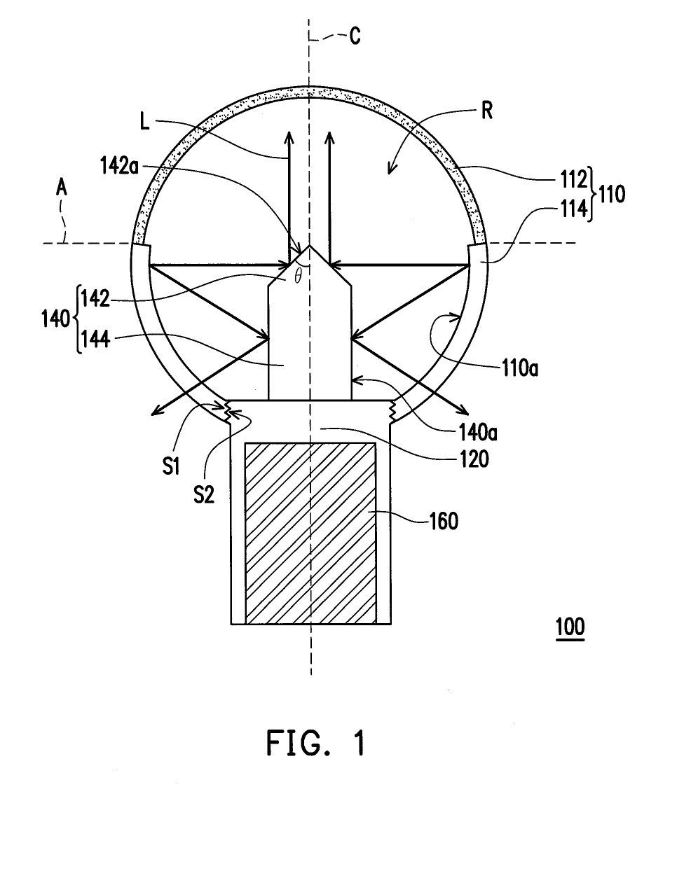

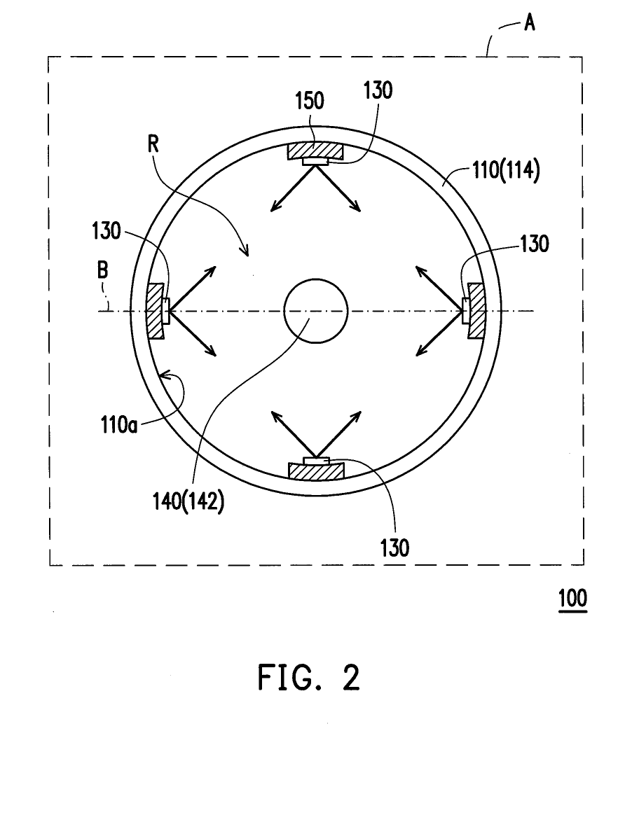

FIG. 1 is a schematic cross-sectional view of an illumination device according to a first embodiment of the present invention. FIG. 2 is a schematic cross-sectional view of an illumination device along a cross section A of FIG. 1. Referring to FIG. 1 and FIG. 2, the illumination device 100 of this embodiment includes a lamp shade 110, a base 120, a plurality of light emitting elements 130 (shown in FIG. 2), and a light guide member 140.

The base 120 is connected to the lamp shade 110, so as to define a receiving space R together with the lamp shade 110. Further, the lamp shade 110 of this embodiment includes an upper shade portion 112, and a lower shade portion 114 connected to the upper shade portion 112 and the base 120. The plurality of light emitting elements 130 of this embodiment may be located on the same cross section A (shown in FIG. 2) of the lamp shade 110, in which the upper shade portion 112 and the lower shade portion 114 are respectively disposed on two sides (shown in FIG. 1) of the cross section A constituted by locations of the light emitting elements 130.

For example, the lamp shade 110 of this embodiment is, for example, a spherical shell, and the light emitting elements 130 are located on the cross section A where a spherical centre of the spherical shell is located. The upper shade portion 112 and the lower shade portion 114 are, for example, an upper part spherical shell and a lower part spherical shell separated by the cross section A. However, the present invention is not limited thereto, a shape of the lamp shade 110 (including the upper shade portion 112 and the lower shade portion 114) and a position defining manner of the upper shade portion 112 and the lower shade portion 114 may be suitably adjusted according to light emission angles and light emission scopes of the light emitting elements 130, a relative position of the light guide member 140 and the light emitting elements 130, environmental conditions of the illumination device, or other practical demands. In this embodiment, a material of the upper shade portion 112 and a material of the lower shade portion 114 may be a light transmissive material, and the surface of the upper shade portion 112 and the surface of the lower shade portion 114 may be hazed, so that after passing through the upper shade portion 112 or the lower shade portion 114, light rays L may be uniformly delivered towards each direction, so that the illumination device 100 has a uniform luminance.

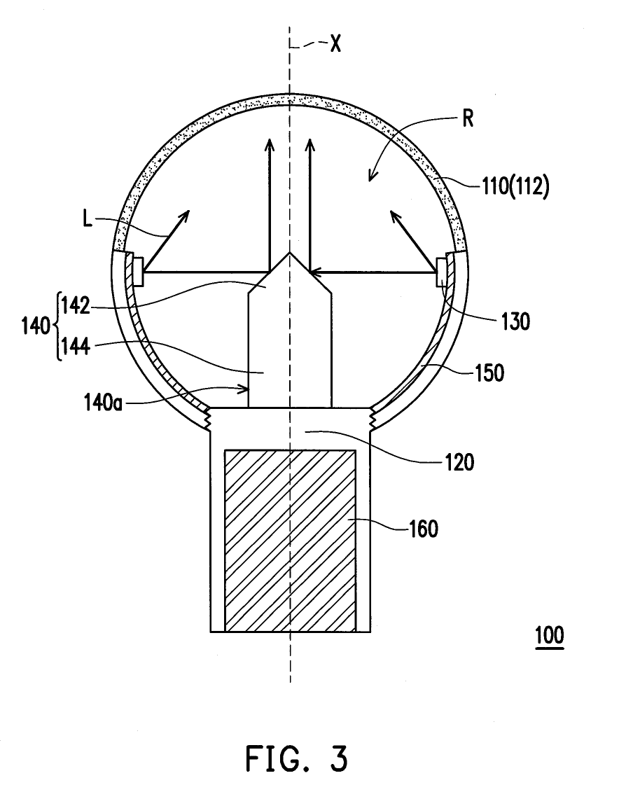

FIG. 3 is a schematic cross-sectional view of an illumination device along a cross section B of FIG. 2. The illumination device 100 of this embodiment may further include a plurality of brackets 150 surroundingly disposed besides the light guide member 140, each bracket 150 extends from the base 120 towards the lamp shade 110, in which each light emitting element 130 is located on a bracket 150. However, the present invention is not limited thereto, in other embodiments, the brackets 150 and the lamp shade 110 may also be respectively disposed on two sides of the light emitting elements 130. For example, the lamp shade 110 may be like the structural form of the upper shade portion 112, that is, a semi-shell shape, and is supported by the brackets 150, in this manner, the area between two adjacent brackets 150 may also be light transmissive. The brackets 150 and the base 120 may be separately formed, or may be integrally formed.

It should be mentioned that in addition to positioning the light emitting elements 130, the brackets 150 can facilitate heat dissipation of the light emitting elements 130, so that the light emitting efficiency of the illumination device 100 becomes excellent. In addition, configuration of the light emitting elements 130 (for example, LEDs) may be rotationally symmetrical or axially symmetrical relative to an axle center X (shown in FIG. 3) of the light guide member 140, so that emission uniformity of the illumination device 100 of this embodiment becomes excellent. In another aspect, since the light emitting elements 130 of this embodiment are surroundingly disposed around the inner wall 110a of the lamp shade 110, the light rays L provided by the light emitting elements 130 are emitted from the lamp shade 110 after being guided by the light guide member 140, so that the light rays are not easily concentrated on a front view direction, thereby mitigating a direct-vision glare problem of a conventional illumination device.

As shown in FIG. 1 and FIG. 3, the illumination device 100 of this embodiment further includes a driver 160. The driver 160 is electrically connected to the light emitting elements 130, for providing a power source and a corresponding signals to the light emitting elements 130, so as to enable the light emitting elements 130 to emit light. In detail, the driver 160 of this embodiment may be electrically connected to the light emitting elements 130 through a transmission line (not shown), in which the transmission line may be adhered to inner surfaces of the brackets 150, so as to be shielded by the brackets 150. However, the present invention is not limited thereto, and in other embodiments, the transmission line may be embedded in the brackets 150.

Referring to FIG. 1 and FIG. 3, the light guide member 140 of this embodiment is located in the receiving space R and is connected to the base 120. The light guide member 140 of this embodiment guides the light rays L emitted by the light emitting elements 130 to the lamp shade 110. In other words, in the illumination device 100, the light rays L emitted by the light emitting elements 130 located around the inner wall 110a of the lamp shade may be uniformly guided to each part of the guide lamp shade 110 by the light guide member 140, so as to modify the darkness problem of the lower half of the conventional illumination device. In detail, the light guide member 140 may guide the light rays L to the lamp shade 110 in a manner of enabling the light rays L to be reflected, refracted or transmitted.

For example, an outer surface 140a of the light guide member 140 of this embodiment may be substantially a light reflecting surface such as a mirror surface or a white reflecting surface. The light guide member 140 of this embodiment includes an upper light guide portion 142 and a lower light guide portion 144. The upper light guide portion 142 guides the light rays L emitted by the light emitting elements 130 toward the upper shade portion 112 of the lamp shade 110. The lower light guide portion 144 is connected to the upper light guide portion 142 and the base 120, and guides the light rays L emitted by the light emitting elements 130 toward the lower shade portion 114 of the lamp shade 110. Through design of the upper light guide portion 142 and the lower light guide portion 144 of this embodiment, in addition to being emitted from the upper shade portion 112 of the lamp shade 110, the light rays L may be emitted from the lower shade portion 114 of the lamp shade 110, so that the lamp shade 110 is totally light transmissive, thereby mitigating the darkness problem of the lower half of the conventional illumination device.

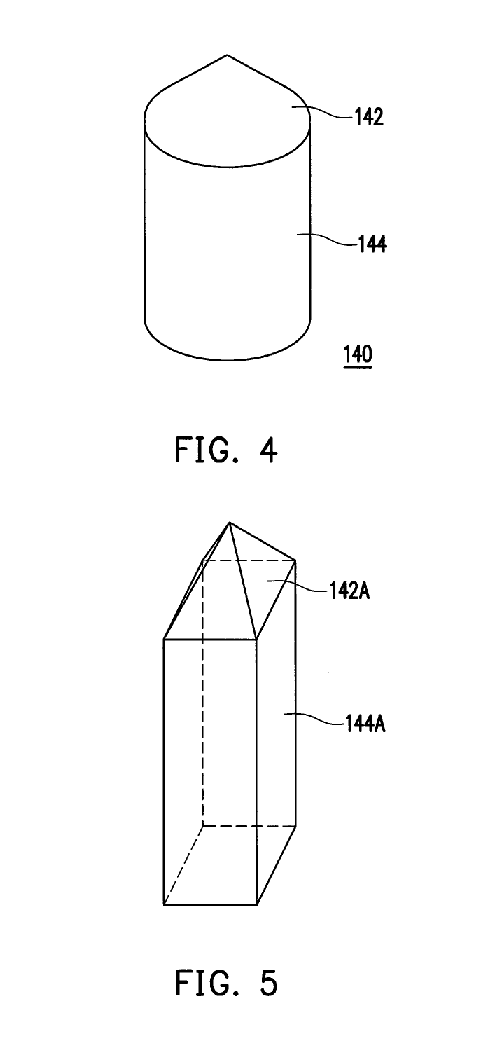

FIG. 4 is a schematic three-dimensional view of a light guide member according to an embodiment of the present invention. FIG. 5 is a schematic three-dimensional view of a light guide member according to another embodiment of the present invention. Referring to FIG. 1 and FIG. 4, the upper light guide portion 142 of this embodiment is substantially a cone, and the lower light guide portion 144 is substantially a cylinder (shown in FIG. 4). Specifically, the light guide member 140 of this embodiment may be mirror-symmetrical relative to a reference plane C (shown in FIG. 1), and an acute angle θ included between a chamfer 142a of the upper light guide portion 142 and the reference plane C may be between 5 degrees and 85 degrees. The reference plane C can be a plane that the axle center X of the light guide member 140 passes through. However, the light guide member of the present invention is not limited thereto, the acute angle θ or an outer shape of the light guide member 140 may be suitably adjusted according to relative positions of the light emitting elements 130 and the light guide member 140, the number, positions, light emission angles, and light emission scopes of the light emitting elements 130, and other practical demands. For example, as shown in FIG. 5, the upper light guide portion 142A is substantially a pyramid, and the lower light guide portion 144A is substantially a polygonal column.

It should be mentioned that in this embodiment, a relative height of the light emitting element 130 and the light guide member 140 may be adjusted. By adjusting the relative height of the light emitting element 130 and the light guide member 140, a proportion of the light rays emitted by the light emitting elements 130 being emitted from the upper shade portion 112 (or the lower shade portion 114) may be controlled. In detail, referring to FIG. 1, the lamp shade 110 of this embodiment may have a screw thread S1, and an outer wall of the base 120 has a screw thread S2. Through matching of the screw thread S1 and the screw thread S2, the relative height of the lamp shade 110 and the light guide member 140 may be changed. In other words, when a user intends to increase the proportion of the light rays being emitted from the upper shade portion 112 (or the lower shade portion 114), one hand of the user may hold the base 120, and the other hand rotates the lamp shade 110, so that most of the light rays emitted by the light emitting elements 140 are towards the upper light guide portion 142, thereby improving a brightness of an upper part of the illumination device 100. Therefore, by adjusting the relative height of the lamp shade 110 and the light guide member 140, brightness distribution of the upper part and a lower part of the illumination device 100 may be adjusted.

In addition, the base 120 of this embodiment may have a guiding groove (not shown). The guiding groove may be surroundingly disposed on a peripheral surface of the base 120. The transmission line (not shown) connected to the light emitting elements 130 and the driver 160 may pass through the base 120 through the guiding groove, so that the light emitting elements 130 are connected to the driver 160. When the user changes the relative height of the light emitting element 130 and the light guide member 140 through the matching of the screw thread Si and the screw thread S2, the transmission line may move together with the lamp shade 110 through guiding of the guiding groove, thereby preventing knotting or damaging. In addition, the base 120 may be further configured with a limiting part (not shown), so as to prevent the user from excessively rotating the lamp shade 110 relative to the base 120, thereby preventing the transmission line (not shown) connected to the light emitting elements 130 and the driver 160 from being damaged during the rotation process.

### Second Embodiment

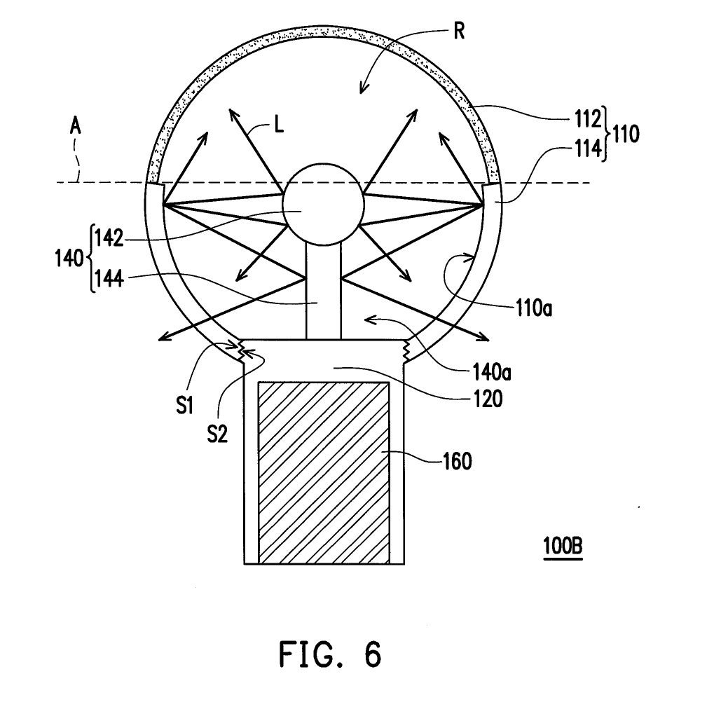

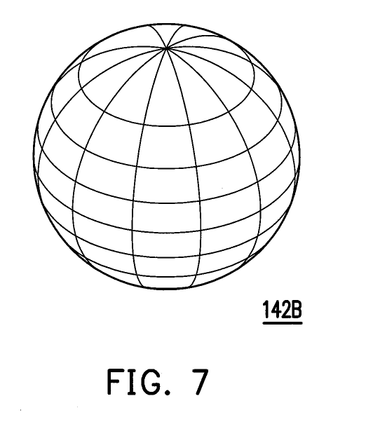

FIG. 6 is a schematic cross-sectional view of an illumination device according to a second embodiment of the present invention. FIG. 7 is a schematic three-dimensional view of an upper light guide portion of FIG. 6. Referring to FIG. 6 and FIG. 7, the illumination device 100B of this embodiment is similar to the illumination device 100 of FIG. 1, so that the elements being the same as that of FIG. 1 are represented by the same symbols. A difference between the two is the outer shape of the upper light guide portion, the difference between the two is described in the following, and the same part is not described.

The difference between the Illumination device 100B of first embodiment and the Illumination device 100 of the first embodiment is the light guide member. The light guide member 140B of this embodiment also includes an upper light guide portion 142B and a lower light guide portion 144. The upper light guide portion 142B guides light rays L emitted by light emitting elements toward an upper shade portion 112 of a lamp shade 110. The lower light guide portion 144 is connected to the upper light guide portion 142B and a base 120, and guides the light rays L emitted by the light emitting elements toward a lower shade portion 114 of the lamp shade 110. In this embodiment, the lower light guide portion 144 may be the same as the lower light guide portion of the first embodiment (being the cylinder), but the upper light guide portion 142B of this embodiment is different from the lower light guide portion of the first embodiment. The upper light guide portion 142B of this embodiment is substantially a sphere.

It should be noted that, the upper light guide portion 142B of this embodiment not only guides the light rays L emitted by the light emitting elements 130 toward the upper shade portion 112 of the lamp shade 110, but also guides the light rays L emitted by the light emitting elements 130 toward the lower shade portion 114 of the lamp shade 110, so that uniformity of the illumination device 100B of this embodiment becomes more excellent. The illumination device 100B of this embodiment and the illumination device 100 of this embodiment have similar efficacies and advantage, and description is omitted here.

### Third Embodiment

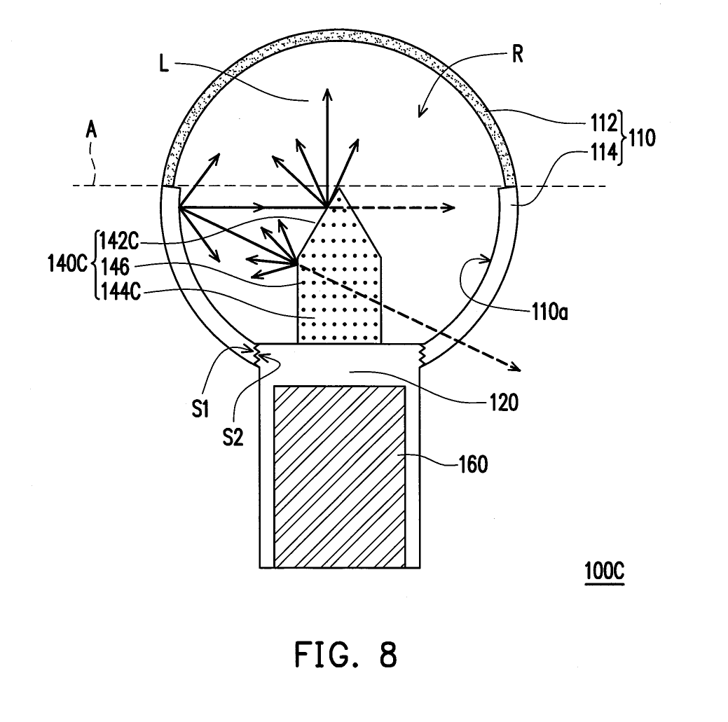

FIG. 8 is a schematic cross-sectional view of an illumination device according to this embodiment. Referring to FIG. 8, the illumination device 100C of this embodiment is similar to the illumination device 100 of FIG. 1, so that the elements being the same that of FIG. 1 are represented by the same symbols. A difference between the two is the light guide member, the difference between the two is described in the following, and the same part is not described.

The difference between the illumination device 100C of this embodiment and the illumination device 100 of the first embodiment is the light guide member. Being different from the first embodiment, a material of a light guide member 140C of this embodiment may be a light transmissive material and further has a plurality of optical microstructures 146. In this embodiment, the material of the light guide member 140C may be polycarbonate (PC), acrylic, or other light transmissive materials. In this embodiment, the light guide member 140C may guide light rays L to a lamp shape 110 in a manner of enabling the light rays L to be reflected, reflected, and transmitted. For example, when the light rays L emitted by light emitting elements 130 are delivered to the optical microstructures 146 located on an upper light guide portion 142C, the light rays L may be scattered by the optical microstructures 146, and are transmitted towards the upper shade portion 112 for being emitted. In addition, the light rays L emitted by the light emitting elements 130 may pass through a light-transmissive lower light guide portion 144C, so as to be emitted from a lower shade portion 114 for being emitted.

The illumination device 100C of this embodiment and the illumination device 100 of this embodiment have similar efficacies and advantage, and description is omitted here.

To sum up, light emitting elements according to an embodiment of the present invention are disposed on brackets surrounding a light guide member, so that light rays emitted by the light emitting elements may be uniform and are not easily concentrated on a front view direction. Therefore, a direct-vision glare problem of a conventional illumination device may be modified. In addition, in an illumination device according to an embodiment of the present invention, the light guide member may distribute the light rays emitted by the light emitting elements to an upper shade portion and a lower shade portion of a lamp shade, thereby modifying a problem of the conventional illumination device that a lower part cannot emit light.

In addition, in the illumination device according to an embodiment of the present invention, a relative height of the light emitting element and the light guide member may be adjusted. A user may change a proportion of the light rays being emitted from the upper shade portion (or the lower shade portion) by adjusting the light emitting element and the light guide member, so as to obtain a desired illumination effect.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An illumination device, comprising:
a lamp shade;
a base, connected to the lamp shade, so as to define a receiving space together with the lamp shade, and comprising a plurality of brackets extending towards the lamp shade;
a plurality of light emitting elements, located in the receiving space and respectively configured on inner walls of the brackets; and
a light guide member, located in the receiving space, surrounded by the brackets, and guiding light rays emitted by the light emitting elements to the lamp shade.

2. The illumination device according to claim 1, wherein the lamp shade and the brackets are respectively disposed on two sides of the light emitting elements.

3. The illumination device according to claim 1, wherein the lamp shade comprises an upper shade portion and a lower shade portion connected to the upper shade portion and the base, the light emitting elements are located on the same cross section of the lamp shade, and the upper shade portion and the lower shade portion are respectively disposed on two sides of the cross section.

4. The illumination device according to claim 3, wherein a material of the upper shade portion and a material of the lower shade portion are a light transmissive material.

5. The illumination device according to claim 3, wherein the light guide member comprises:
an upper light guide portion, guiding the light rays emitted by the light emitting elements toward the upper shade portion of the lamp shade; and
a lower light guide portion, connected to the upper light guide portion and the base, and guiding the light rays emitted by the light emitting elements toward the lower shade portion of the lamp shade.

6. The illumination device according to claim 5, wherein the upper light guide portion is substantially a cone or a sphere.

7. The illumination device according to claim 6, wherein the lower light guide portion is substantially a cylinder.

8. The illumination device according to claim 6, wherein the light guide member is mirror-symmetrical relative to a reference plane, and an acute angle included between a chamfer of the cone and the reference plane is between 5 degrees to 85 degrees.

9. The illumination device according to claim 5, wherein the upper light guide portion is substantially a pyramid.

10. The illumination device according to claim 9, wherein the lower light guide portion is substantially a polygonal column.

11. The illumination device according to claim 1, wherein an outer surface of the light guide member is substantially a light reflecting surface.

12. The illumination device according to claim 1, wherein a material of the light guide member is a light transmissive material, and the light guide member comprises a plurality of optical microstructures.

13. The illumination device according to claim 1, wherein a relative height of the light emitting element and the light guide member is adjustable.
